(19) United States
(12) Patent Application Publication
(10) Pub. No.: US 2025/0145909 A1
(43) Pub. Date: May 8, 2025

(54) Home Care Compositions

(71) Applicant: Colgate-Palmolive Company, New York, NY (US)

(72) Inventors: Elvia Patricia VALADEZ SANCHEZ, Atizapan de Zaragoza (MX); Sandra Paola SANCHEZ RODRIGUEZ, Mexico City (MX)

(73) Assignee: Colgate-Palmolive Company, New York, NY (US)

(21) Appl. No.: 18/930,363

(22) Filed: Oct. 29, 2024

Related U.S. Application Data
(60) Provisional application No. 63/595,676, filed on Nov. 2, 2023.

(51) Int. Cl. C11D 3/20; C11D 1/75; C11D 1/88; C11D 3/04; C11D 3/48

(52) U.S. Cl. CPC C11D 3/2082; C11D 1/75; C11D 1/88; C11D 3/044; C11D 3/201; C11D 3/2044; C11D 3/2048; C11D 3/2068; C11D 3/48; C11D 2111/14

(57) ABSTRACT

Home care compositions having antibacterial properties are disclosed herein. The home care compositions disclosed herein comprise citric acid in an amount greater than about 1 wt %, at least one surfactant, and at least one solvent, and have a pH ranging from about 7 to about 14.

### CROSS-REFERENCE TO RELATED APPLICATION

This application claims the benefit of priority from U.S. Provisional Patent Application No. 63/595,676, filed 2 Nov. 2023, the contents of which are hereby incorporated herein by reference in their entirety.

### BACKGROUND

Conventional home care products, such as hard surface cleaners and compositions thereof, often utilize disinfecting and/or preserving ingredients, such as antimicrobial agents. Such disinfectant cleaning compositions for use on hard surfaces are known in the art. Hard surfaces may include household surfaces such as those typically found in bathrooms and kitchens, and include a variety of different materials such as enamel, ceramic, granite, plastic, porcelain, metal, glass, and the like. Such surfaces include fixtures such as countertops, appliances (e.g., refrigerators, stoves) as well as bathtubs, sinks, and toilets.

Acidic cleansers are known that purport to provide activity against mineral deposits, e.g., lime scale or soap scum. Some of these cleaners are marketed as being useful for limescale and rust removal, and are said to be dependent upon a certain pH range to retain the desired activity.

However, an ongoing need exists for improved hard surfaces cleaners that have antimicrobial activity, including antibacterial activity, for use in cleaning hard surfaces of known household pathogens, including viruses, bacteria, mold, and yeast found in food products and the environment and known to cause human disease. In particular, cleaning compositions that are useful as disinfectant sprays are desirable.

Typical antibacterial agents added to home care compositions, however, may be both expensive and undesirable as not being natural and/or organic. Moreover, home care compositions having a very low or acidic pH may be harsh under certain conditions and uses.

In view of the foregoing, improved, affordable home care products that do not contain undesirable ingredients, are stable, are neutral to slightly basic, and that may be used for effectively disinfecting surfaces are needed.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

Aspects of the disclosure are directed to home care compositions having antimicrobial (e.g., antibacterial and/or antifungal) properties. In accordance with an aspect of the disclosure, provided is a home care composition comprising citric acid in an amount greater than about 1 wt % (such as an amount of greater than about 1 wt % to about 5 wt %, such as about 2.5 wt %, about 4 wt %, or about 5 wt %), based on the total weight of the home care composition; at least one surfactant; and at least one solvent, wherein the home care composition has a pH ranging from about 7 to about 14, such as a pH ranging from about 7 to about 10, such as about 7, about 7.5, about 8, about 8.5, about 9, or about 9.5.

In certain aspects of the disclosure, the at least one surfactant is an amphoteric surfactant, such as an amine oxide amphoteric surfactant, such as lauryl dimethyl amine oxide. In certain aspects, the at least one surfactant is present in the home care composition in an amount ranging from about 1 wt % to about 20 wt % to about 1 wt % to about 10 wt %, or about 5 wt %, based on the total weight of the home care composition.

In certain aspects of the disclosure, the home care composition further comprises a fragrance, optionally present in an amount ranging from about 0.01 wt % to about 4 wt %, about 0.1 wt % to about 1 wt %, or about 0.3 wt % to about 0.4 wt %, based on the total weight of the home care composition. In certain aspects, the home care composition further comprises at least one antimicrobial boosting agent, such as ethylhexylglycerin and/or caprylyl glycol, optionally present in an amount ranging from about 0.01 wt % to about 5 wt %, such as about 0.1 wt % to about 1 wt %, or about 0.25 wt %, based on the total weight of the home care composition. In certain aspects, the home care composition further comprises a base, such as sodium hydroxide, as a pH modifying agent. In certain embodiments, the home care composition is a disinfectant home care composition.

According to certain aspects of the disclosure, the home care composition disclosed herein has a micro robustness index of at least about 0.85, such as at least about 1.0, at least about 1.2, at least about 1.3, or at least about 1.4, and according to certain aspects, the home care composition provides at least a 2-log reduction, such as at least a 3-log reduction, at least a 4-log reduction, at least a 5-log reduction, or at least a 6-log reduction in a bacterial population. In certain aspects, the bacterial population comprises at least one bacteria selected from Gram-negative bacteria, such as E. coli and/or P. aeruginosa, and in certain aspects, the bacterial population comprises at least one bacteria selected from Gram-positive bacteria, such as S. aureus and E. hirae.

In accordance with another aspect of the disclosure, provided is a method of disinfecting a surface by killing at least one bacteria, the method comprising applying to the surface a home care composition comprising citric acid in an amount greater than about 1 wt %, based on the total weight of the home care composition; at least one surfactant; and at least one solvent, wherein the home care composition has a pH ranging from about 7 to about 14. In certain aspects of the methods disclosed herein, the surface is a hard surface, and in certain aspects, the home care composition is applied as a liquid spray. In certain aspects, the method provides at least a 2-log reduction, such as at least a 3-log reduction, at least a 4-log reduction, at least a 5-log reduction, or at least a 6-log reduction in a bacterial population on the surface.

### BRIEF DESCRIPTION OF THE DRAWINGS

The features, and advantages of the disclosure will be apparent from the following more detailed description of certain embodiments and as illustrated in the accompanying drawings in which:

FIG. 1A is a graph showing the pH over time for the comparative Composition A, as described in Example 1.

FIG. 1B is a graph showing the pH over time for the comparative Composition B, as described in Example 1, comprising DDAC as an antimicrobial agent.

FIG. 1C is a graph showing the pH over time for Composition 1, as described in Example 1, comprising 1% citric acid and having an initial pH of 8.5.

FIG. 1D is a graph showing the pH over time for Composition 2, as described in Example 1, comprising 1% citric acid and having an initial pH of 9.5.

FIG. 1E is a graph showing the pH over time for Composition 3, as described in Example 1, comprising 5% citric acid and having an initial pH of 8.5.

FIG. 1F is a graph showing the pH over time for Composition 4, as described in Example 1, comprising 5% citric acid and having an initial pH of 9.5.

FIG. 1G is a graph showing the pH over time for Composition 5, as described in Example 1, comprising 5% citric acid and ethylhexylglycerin and having an initial pH of 8.5.

FIG. 1H is a graph showing the pH over time for Composition 6, as described in Example 1, comprising 5% citric acid and caprylyl glycol and having an initial pH of 8.5.

FIG. 2A is a graph showing the pH over time for Composition A, as described in Example 3.

FIG. 2B is a graph showing the pH over time for Composition B, as described in Example 3.

FIG. 2C is a graph showing the pH over time for Composition 7, as described in Example 3, comprising 2.5% citric acid and having an initial pH of 7.5.

FIG. 2D is a graph showing the pH over time for Composition 8, as described in Example 3, comprising 2.5% citric acid and having an initial pH of 8.5.

FIG. 2E is a graph showing the pH over time for Composition 9, as described in Example 3, comprising 4% citric acid and having an initial pH of 7.5.

FIG. 2F is a graph showing the pH over time for Composition 10, as described in Example 3, comprising 4% citric acid and having an initial pH of 8.5.

It should be understood that the various aspects are not limited to the compositions, arrangements, and instrumentality shown in the figures.

### DETAILED DESCRIPTION

For illustrative purposes, the principles of the present disclosure are described by referencing various exemplary embodiments thereof. Although certain embodiments are specifically described herein, one of ordinary skill in the art will readily recognize that the same principles are equally applicable to, and can be employed in other compositions and methods. Before explaining the disclosed embodiments in detail, it is to be understood that the disclosure is not limited in its application to the details of any particular embodiment disclosed herein. The terminology used herein is for the purpose of description and not of limitation.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but not limited to”.

As used throughout, ranges are used as shorthand for describing each and every value that is within the range. Any value within the range can be selected as the terminus of the range. Thus, a range from 1-5, includes specifically 1, 2, 3, 4 and 5, as well as subranges, such as 2-5, 3-5, 2-3, 2-4, 1-4, etc.

The term “about” when referring to a number means any number within a range of 10% of the number. For example, the phrase “about 2 wt. %” refers to a number between and including 1.8 wt. % and 2.2 wt. %.

All references cited herein are hereby incorporated by reference in their entireties. In the event of a conflict in a definition in the present disclosure and that of a cited reference, the present disclosure controls.

The abbreviations and symbols as used herein, unless indicated otherwise, take their ordinary meaning. The abbreviation “wt %” or “wt. %” means percent by weight with respect to the home care composition, unless indicated otherwise. The symbol “∘” refers to a degree, such as a temperature degree or a degree of an angle. The symbols “h”, “min”, “mL”, “nm”, and “μm” refer to hour, minute, milliliter, nanometer, and micrometer, respectively. The abbreviation “UV-VIS” referring to a spectrometer or spectroscopy, means Ultraviolet-Visible. The abbreviation “rpm” means revolutions per minute.

When referring to chemical structures, and names, the symbols “C”, “H”, and “O” mean carbon, hydrogen, and oxygen, respectively. The symbols “—”, “═”, and “≡” mean single bond, double bond, and triple bond, respectively.

“Volatile”, as used herein, means having a flash point of less than about 100° C. “Non-volatile”, as used herein, means having a flash point of greater than about 100° C.

Any member in a list of species that are used to exemplify or define a genus, may be mutually different from, or overlapping with, or a subset of, or equivalent to, or nearly the same as, or identical to, any other member of the list of species. Further, unless explicitly stated, such as when reciting a Markush group, the list of species that define or exemplify the genus is open, and it is given that other species may exist that define or exemplify the genus just as well as, or better than, any other species listed.

The phrases, “a mixture thereof,” “a combination thereof,” or “a combination of two or more thereof” do not require that the mixture include all of A, B, C, D, E, and F (although all of A, B, C, D, E, and F may be included). Rather, it indicates that a mixture of any two or more of A, B, C, D, E, and F can be included. In other words, it is equivalent to the phrase “one or more elements selected from the group consisting of A, B, C, D, E, F, and a mixture of any two or more of A, B, C, D, E, and F.” Likewise, the term “a salt thereof” also relates to “salts thereof.” Thus, where the disclosure refers to “an element selected from the group consisting of A, B, C, D, E, F, a salt thereof, and a mixture thereof,” it indicates that one or more of A, B, C, D, and F may be included, one or more of a salt of A, a salt of B, a salt of C, a salt of D, a salt of E, and a salt of F may be included, or a mixture of any two of A, B, C, D, E, F, a salt of A, a salt of B, a salt of C, a salt of D, a salt of E, and a salt of F may be included.

All components and elements positively set forth in this disclosure can be negatively excluded from the claims. In other words, the home care compositions of the instant disclosure can be free or essentially free of all components and elements positively recited throughout the instant disclosure. In some instances, the home care compositions of the present disclosure may be substantially free of non-incidental amounts of the ingredient(s) or compound(s) described herein. A non-incidental amount of an ingredient or compound is the amount of that ingredient or compound that is added into the home care composition by itself. For example, a home care composition may be substantially free of a non-incidental amount of an ingredient or compound, although such ingredient(s) or compound(s) may be present as part of a raw material that is included as a blend of two or more compounds.

Some of the various categories of components identified may overlap. In such cases where overlap may exist and the home care composition includes both components (or the composition includes more than two components that overlap), an overlapping compound does not represent more than one component. For example, certain compounds may be characterized as both a pH modifying agent and an antibacterial agent. If a particular home care composition includes both a pH modifying agent and an antibacterial agent, a particular compound will serve only as either the a pH modifying agent or an antibacterial agent—not both.

For readability purposes, the chemical functional groups are in their adjective form; for each of the adjectives, the word “group” is assumed. For example, the adjective “alkyl” without a noun thereafter, should be read as “an alkyl group.”

Aspects of the disclosure are directed to home care compositions having antimicrobial, e.g., antibacterial, properties. In accordance with an aspect of the disclosure, provided is a home care composition comprising citric acid and having a basic pH greater than about 7. Without being limited to any particular theory, the home care compositions disclosed herein advantageously have strong antimicrobial properties without the use of harsh or undesirable antimicrobial agents.

Citric acid is 2-hydroxypropane-1,2,3-tricarboxylic acid having the formula C₆H₈O₇. Citric acid is a weak acid with three carboxylic functional groups, having three different dissociation values (pKa) of 3.1, 4.7, and 6.4. Citric acid has both preservative and antibacterial properties at low pH, e.g., less than about 6. Nevertheless, at high pH levels, the fully ionized species of citric acid dominates. Because citric acid is a triprotic acid, it possesses three negatively charge species with increasing pH, as follows: CAH₃→CAH₂⁻→CAH²⁻→CA³⁻. Thus, at a pH of about 4.5, approximately 70% is in the form CAH₂⁻, while approximately 5% takes the CAH₃ form and approximately 25% takes the CAH²⁻. Burel, C. et al., Impact of pH on citric acid antimicrobial activity against Gram-negative bacteria, Ltrs Appl Microbio 2021, 72:332-340. As the pH increases to 6.5, approximately 50% is present as CAH²⁻ and 50% is present as CA³⁻. When the pH is increased to 9.5, however, approximately 100% of the citric acid is present as CA³⁻. Thus, the fully ionized species of CA³⁻ dominates in a solution having a basic pH. Without being bound by theory, it is believed that the fully ionized species of citric acid may provide a superior chelating activity that adversely affects a microorganism's growth environment.

In accordance with an aspect of the disclosure, provided is a home care composition comprising citric acid in an amount greater than about 1 wt %, based on the total weight of the home care composition; at least one surfactant; and at least one solvent, wherein the home care composition has a pH ranging from about 7 to about 14.

The home care compositions disclosed herein comprises citric acid in an amount greater than about 1 wt %. For example, the home care compositions may comprise citric acid in an amount of greater than about 1 wt % to about 10 wt %, such as greater than about 1 wt % to about 8 wt %, greater than about 1 wt % to about 6 wt %, greater than about 1 wt % to about 5 wt %, greater than about 1 wt % to about 4 wt %, greater than about 1 wt % to about 3 wt %, greater than about 1 wt % to about 2 wt %, about 2 wt % to about 8 wt %, about 2 wt % to about 6 wt %, about 2 wt % to about 5 wt %, about 2 wt % to about 4 wt %, about 2 wt % to about 3 wt %, about 3 wt % to about 8 wt %, about 3 wt % to about 6 wt %, about 3 wt % to about 5 wt %, about 3 wt % to about 4 wt %, about 4 wt % to about 8 wt %, about 4 wt % to about 6 wt %, about 4 wt % to about 5 wt %, or any range or subrange thereof, based on the total weight of the home care composition. In certain embodiments, the home care composition disclosed herein comprises citric acid in an amount greater than about 1 wt %, such as about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, or about 5 wt %, based on the total weight of the home care composition.

The home care compositions disclosed herein may further comprise at least one surfactant. The at least one surfactant may be present in the home care compositions in an amount from about 1 wt % to about 20 wt %, based on the total weight of the home care composition. For instance, the home care composition may comprise a total amount of surfactant of about 1 wt % to about 15 wt %, about 1 wt % to about 12 wt %, about 1 wt % to about 9 wt %, about 1 wt % to about 7 wt %, about 1 wt % to about 5 wt %, about 1 wt % to about 4 wt %, about 1 wt % to about 3 wt %, about 1 wt % to about 2 wt %; from about 2 wt % to about 15 wt %, about 2 wt % to about 12 wt %, about 2 wt % to about 9 wt %, about 2 wt % to about 7 wt %, about 2 wt % to about 5 wt %, about 2 wt % to about 4 wt %, about 2 wt % to about 3 wt %; from about 3 wt % to about 15 wt %, about 3 wt % to about 12 wt %, about 3 wt % to about 9 wt %, about 3 wt % to about 7 wt %, about 3 wt % to about 5 wt %, about 3 wt % to about 4 wt %; from about 5 wt % to about 15 wt %, about 5 wt % to about 12 wt %, about 5 wt % to about 9 wt %, about 5 wt % to about 7 wt %, or any range or subrange thereof, based on the total weight of the home care composition. In certain embodiments, the at least one surfactant may be present in the home care composition in an amount of about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %, such as about 5 wt %, based on the total weight of the home care composition.

The at least one surfactant may comprise an anionic surfactant, an amphoteric surfactant, a nonionic surfactant, or a combination thereof. In certain embodiments, the anionic surfactant may be selected from sulfate anionic surfactants and/or salts thereof, including those selected from alkyl sulfates and alkyl ether sulfates. The alkyl sulfates and/or alkyl ether sulfates may have an alkyl group comprising from 8 to 20 carbon atoms, 8 to 16 carbon atoms, 10 to 16 carbon atoms, or 10 to 13 carbon atoms. Non-limiting examples of alkyl sulfate and alkyl ether sulfate salts include sodium lauryl sulfate (SLS), sodium dodecyl sulfate (SDS), sodium lauryl ether sulfate (SLES), ammonium lauryl sulfate, and ammonium laureth sulfate. In some embodiments, the sulfate anionic surfactants include sodium lauryl sulfate, sodium laureth sulfate, a salt thereof, or a combination of two or more thereof. The anionic surfactant may comprise non-sulfate surfactants, such as Olefin Sulfonate and internal olefin sulfonates. In at least one embodiment, the one or more surfactants comprises a reaction product of hexadecene with sulfur trioxide, hydrolyzed, potassium salts. In further embodiments, the one or more surfactants may be selected from rhamnolipids, sophorolipids, or a combination thereof. The sophorolipids may be fermentation products of glucose and fatty acids, C18-unsaturated, esters with glycerol with yeast Candida Bombicola, partially hydrolysed.

Additionally or alternatively, the home care composition may include at least one amphoteric surfactant. The home care composition may include an amine oxide amphoteric surfactant. The amine oxide amphoteric surfactant may comprise an alkyl dimethyl amine oxide surfactant in which the alkyl group typically has from 8 to 18 carbon atoms. The amine oxide amphoteric surfactant may have a structuring according to the following formula: R₁R₂R₃N+O—, wherein R₁ comprises 8 to 18 carbon atoms and R₂ and R₃ each contain 1-4 carbon atoms. R₂ and R₃ each preferably contain 1 or 2 carbon atoms. For instance, both R₂ and R₃ may be methyl. In some embodiments, R₁ is selected from alkyl groups with 8 to 18 carbon atoms, in particular 10 to 16 carbon atoms, more in particular 10 to 14 carbon atoms. The amine oxide amphoteric surfactant may be selected from C₈-C₁₈ dimethyl amine oxides, in particular C₁₀-C₁₆ dimethyl amine oxides, more in particular C₁₀-C₁₄ dimethyl amine oxides. C₁₀ (decyl) and C₁₂ (dodecyl or lauryl)dimethyl amine oxides may provide particularly good results when incorporated into certain embodiments of the home care composition disclosed herein. Coco-dimethyl amine oxide, which is a mixture of C₁₀-C₁₈ dimethyl amine oxides may also be useful.

In certain embodiments, the amine oxide amphoteric surfactant is C₁₂-C₁₄ alkyl amidopropyl dimethylamine oxide. In certain embodiments, the amine oxide amphoteric surfactant is selected from a C₁₂ alkyl amidopropyl dimethylamine oxide, a C₁₄ alkyl amidopropyl dimethylamine oxide, and a mixture thereof. The alkyl dimethyl amine oxide may be chosen from lauryl dimethyl amine oxide, myristyl dimethyl amine oxide or a mixture thereof. In certain embodiments, the amine oxide amphoteric surfactant is selected from lauryl amidopropyl dimethylamine oxide, myristyl amidopropyl dimethylamine oxide, and a mixture thereof. In certain embodiments, the amine oxide amphoteric surfactant has a density of about 0.99 g/ml. In certain embodiments, the amine oxide amphoteric surfactant has a viscosity of about 45 cps at 25° C. In certain embodiments, the amine oxide amphoteric surfactant is lauryl dimethyl amine oxide. In certain embodiments of the home care composition disclosed herein, the at least one surfactant comprises or consists of lauryl dimethyl amine oxide.

The at least one amphoteric surfactant may be selected from betaine surfactants (also referred to as betaines). Examples of amphoteric surfactants include, but are not limited to, a range of betaines including, for example, high alkyl betaines, such as coco dimethyl carboxymethyl betaine, lauryl dimethyl carboxy-methyl betaine, lauryl dimethyl alpha-carboxyethyl betaine, cetyl dimethyl carboxymethyl betaine, lauryl bis-(2-hydroxyethyl) carboxy methyl betaine, stearyl bis-(2-hydroxypropyl) carboxymethyl betaine, oleyl dimethyl gamma-carboxypropyl betaine, and lauryl bis-(2-hydroxypropyl) alpha-carboxyethyl betaine, sulfobetaines such as coco dimethyl sulfopropyl betaine, stearyl dimethyl sulfopropyl betaine, amido betaines, amidosulfobetaines, and mixtures thereof.

In certain embodiments, a betaine surfactant is selected from coca betaine, cocamidopropyl betaine, lauryl betaine, laurylhydroxy sulfobetaine, lauryldimethyl betaine, cocamidopropyl hydroxysultaine, behenyl betaine, capryl/capramidopropyl betaine, lauryl hydroxysultaine, stearyl betaine, and combinations of two or more thereof. In some embodiments, at least one betaine surfactant is selected from coco betaine, cocamidopropyl betaine, behenyl betaine, capryl/capramidopropyl betaine, lauryl betaine, and a combination of two or more thereof. In some instances, the betaine surfactant is, preferably, selected from coca betaine, cocamidopropyl betaine, lauryl betaine, laurylhydroxy sulfobetaine, lauryldimethyl betaine, cocamidopropyl hydroxysultaine, behenyl betaine, capryl/capramidopropyl betaine, lauryl hydroxysultaine, stearyl betaine, and a combination of two or more thereof. In at least one embodiment, the home care composition comprises coco betaine, cocamidopropyl betaine, or a combination thereof.

The amphoteric surfactant may, in some cases, be selected sultaines, also known as sulfobetaines, and hydroxy sultaines, e.g., cocamidopropyl hydroxysultain. The sultaines may be an alkyl sultaines having from 6 to 20 carbons, 8 to 18 carbons, 8 to 16 carbons, or 10 to 16 carbons. Examples of alkyl sultaine surfactants include, but are not limited to, cocamidopropyl hydroxysultaine, lauryl hydroxysultaine, and a combination of two or more thereof.

In some embodiments, the at least one surfactant includes an amphoteric surfactant selected from amine oxide amphoteric surfactants, such as lauryl dimethyl amine oxide.

The one or more surfactants may, additionally or alternatively, include a nonionic surfactant. The nonionic surfactant may be selected from alkyl polyglucosides, alkylamides, alkanolamides, polyoxyalkylenated nonionic surfactants, polyglycerolated nonionic surfactants, ethoxylated fatty esters (such as, polyglyceryl-2-caprate), and a combination of two or more thereof. In some cases, the nonionic surfactant may be selected from alkyl polyglucosides, alkylamides, and/or alkanolamides and may have an alkyl group having 8 to 32 carbons, 8 to 26 carbons, 8 to 22 carbons, 8 to 18 carbons, 10 to 22 carbons, 10 to 18 carbons, 12 to 22 carbons, or 12 to 18 carbons. In at least one embodiment, the nonionic surfactant comprises an alkyl polyglucoside, an alkylamide, an alkanolamide, or a combination of two or more thereof having an alkyl group of 12 to 18 carbons.

The nonionic surfactant may be selected from alkyl polyglucosides in some cases. In some instances, the alkyl polyglucoside(s) are chosen from lauryl glucoside, octyl glucoside, decyl glucoside, coco glucoside, caprylyl/capryl glucoside, sodium lauryl glucose carboxylate, and a combination of two or more thereof. In at least one embodiment, the home care composition includes one or more nonionic surfactant comprising caprylyl glucoside and/or caprylyl/capryl glucoside. Non-limiting examples of nonionic surfactants worth mentioning include esters of polyols with fatty acids having a saturated or unsaturated chain, e.g., containing from 8 to 24 carbon atoms or 12 to 22 carbon atoms, and/or alkoxylated derivatives thereof. For example, the home care composition may comprise polyethylene glycol esters of a C₈-C₂₄, such as C₁₂-C₂₂ glycol esters; sorbitol esters of a C₈-C₂₄, such as C₁₂-C₂₂ sorbitol esters; sugar (sucrose, glucose, alkylglycose) esters of a C₈-C₂₄; ethers of sugar and a C₈-C₂₄; or combinations of two or more thereof.

The nonionic surfactant may be selected from alkoxylated alcohols, e.g., having about 1 to about 100 moles of an alkylene oxide per mole of alkoxylated alcohol. As examples of alkoxylated fatty alcohols, steareth (for example, steareth-2, steareth-20, and steareth-21), laureth (for example, laureth-4, and laureth-12), ceteth (for example, ceteth-10 and ceteth-20) and ceteareth (for example, ceteareth-2, ceteareth-10, and ceteareth-20) are worth mentioning. In at least one instance, the one or more alkoxylated fatty alcohols include steareth-20. In some instances, the one or more alkoxylated fatty alcohols may be exclusively steareth-20. The alkylated fatty alcohols may include ethoxylated octan-1-ol, C₁₁₋₁₅ pareth, PPG C₁₂₋₁₄ pareth, or a combination of two or more thereof.

In some instances, the nonionic surfactant may comprise a fatty alcohol derivative, such as methyl stearyl ether; 2-ethylhexyl dodecyl ether; stearyl acetate; cetyl propionate; the ceteth series of compounds, such as ceteth-1 through ceteth-45, which are ethylene glycol ethers of cetyl alcohol, wherein the numeric designation indicates the number of ethylene glycol moieties present; the steareth series of compounds such as steareth-1 through 10, which are ethylene glycol ethers of steareth alcohol, wherein the numeric designation indicates the number of ethylene glycol moieties present; ceteareth 1 through ceteareth-10, which are the ethylene glycol ethers of ceteareth alcohol, i.e., a mixture of fatty alcohols containing predominantly cetyl and stearyl alcohol, wherein the numeric designation indicates the number of ethylene glycol moieties present; C₁-C₃₀ alkyl ethers of the ceteth, steareth, and ceteareth compounds described above; polyoxyethylene ethers of branched alcohols, such as octyldodecyl alcohol, dodecylpentadecyl alcohol, hexyldecyl alcohol, and isostearyl alcohol; polyoxyethylene ethers of behenyl alcohol; PPG ethers, such as PPG-9-steareth-3, PPG-11 stearyl ether, PPG8-ceteth-1, and PPG-10 cetyl ether; and a combination of two or more thereof.

The nonionic surfactants may be selected from ethoxylated fatty esters, such as adducts of ethylene oxide with esters of lauric acid, palmitic acid, stearic acid, behenic acid, and mixtures thereof, including those containing from 9 to 100 oxyethylene groups. In some cases, the ethoxylated fatty esters may comprise PEG-9 laurate to PEG-50 laurate; PEG-9 palmitate to PEG-50 palmitate; PEG-9 stearate to PEG-50 stearate; PEG-9 palmitostearate to PEG-50 palmitostearate; PEG-9 behenate to PEG-50 behenate; polyethylene glycol 100 EO monostearate (such as, PEG-100 stearate); or combinations of two or more thereof. As examples of glyceryl esters of fatty acids, glyceryl stearate (glyceryl mono-, di- and/or tristearate), glyceryl ricinoleate, and a combination of two or more thereof may be incorporated in the home care composition. Examples of glyceryl esters of C₈-C₂₄ alkoxylated fatty acids include polyethoxylated glyceryl stearate (glyceryl mono-, di- and/or tristearate), such as PEG-20 glyceryl stearate.

In certain embodiments disclosed herein, the home care composition comprises at least one solvent. In certain embodiments, the at least one solvent may be a polyol, such as a glycol. In certain embodiments, the at least one solvent may be an alcohol, such as an ethyl alcohol. In certain embodiments, the at least one solvent is a solvent mixture, such as a solvent mixture comprising a glycol ether and an ethyl alcohol. Additional solvents, such as water, may be present in the home care composition in addition to the glycol ether and the alcohol.

In certain embodiments, the at least one solvent is a glycol ether. A glycol ether solvent has the formula R—O—(CH₂CH₂O)ₘ—CH₂CH₂—OH, wherein m=0 or 1, and R is a hydrocarbyl group comprising 1 to 7 carbons. The term “hydrocarbyl” means a univalent group comprising only carbon and hydrogen atoms; the hydrocarbyl group may be saturated, it may be unsaturated, it may be partially saturated, it may be branched, it may be linear, it may be alicyclic, it may be cyclic. The glycol ether may be present in an amount ranging from about 0.1 wt % to about 2 wt % by weight of the composition, such as about 0.5 wt % to about 1.5 wt %, or about 1 wt %. Glycol ether solvent is particularly suitable for cleaning compositions.

Examples of glycol ether solvents may include, for example, propylene glycol N-butyl ether, ethylene glycol monomethyl ether, 2-methoxyethanol, CH₃OCH₂CH₂OH, ethylene glycol monoethyl ether, 2-ethoxyethanol, CH₃CH₂OCH₂CH₂OH, ethylene glycol monopropyl ether, 2-propoxyethanol, CH₃CH₂CH₂OCH₂CH₂OH, ethylene glycol monoisopropyl ether, 2-isopropoxyethanol, (CH₃)₂CHOCH₂CH₂OH, ethylene glycol monobutyl ether, 2-butoxyethanol, CH₃CH₂CH₂CH₂OCH₂CH₂OH, ethylene glycol monophenyl ether, 2-phenoxyethanol, C₆H₅OCH₂CH₂OH, ethylene glycol monobenzyl ether, 2-benzyloxyethanol, C₆H₅CH₂OCH₂CH₂OH, propylene glycol methyl ether, 1-methoxy-2-propanol, CH₃OCH₂CH(OH)CH₃, diethylene glycol monomethyl ether, 2-(2-methoxyethoxy) ethanol, methyl carbitol, CH₃OCH₂CH₂OCH₂CH₂OH, diethylene glycol monoethyl ether, 2-(2-ethoxyethoxy) ethanol, carbitol cellosolve, CH₃CH₂OCH₂CH₂OCH₂CH₂OH, diethylene glycol mono-n-butyl ether, 2-(2-butoxyethoxy) ethanol, butyl carbitol, CH₃CH₂CH₂CH₂OCH₂CH₂OCH₂CH₂OH, and mixtures thereof.

Under one embodiment, the glycol ether is present in an amount ranging from about 0.1 wt % to about 5 wt % by weight of the home care composition. Under one embodiment, the glycol ether is present in an amount ranging from about 0.1 wt % to about 2 wt % by weight of the home care composition. Under one embodiment, the glycol ether is present in an amount ranging from about 0.5 wt % to about 1.5 wt % by weight of the home care composition.

In certain embodiments, the at least one solvent comprises an alcohol, such as a solvent mixture comprising an alcohol. An alcohol is a compound comprising a hydroxyl functional group bound to a carbon. The alcohol may be a primary alcohol, secondary alcohol, or a tertiary alcohol. Under one embodiment, the alcohol solvent has the formula R—OH, wherein R is an organic group 1 to 8 carbons. The organic group may be saturated, unsaturated, partially saturated, branched, linear, alicyclic, or cyclic. Further, the organic group may contain other groups such as ethers, or hydroxyl groups. In certain embodiments, the alcohol may be ethanol. The alcohol may be present in an amount ranging from about 0.1 wt % to about 10 wt %, or from about 0.5 wt % to about 4 wt %.

Examples of alcohol solvents include may include ethyl alcohol, tert-amyl alcohol, benzyl alcohol, 1,4-butanediol, 1,2,4-butanetriol, butanol, 2-butanol, n-butanol, tert-butyl alcohol, diethylene glycol, ethanol, ethylene glycol, 2-ethylhexanol, furfuryl alcohol, glycerol, isobutanol, isopropyl alcohol, methanol, 2-(2-methoxyethoxy) ethanol, 2-methyl-1-butanol, 2-methyl-1-pentanol, 3-methyl-2-butanol, neopentyl alcohol, 2-pentanol, 1,3-propanediol, 1-propanol, propylene glycol, propylene glycol methyl ether, and mixtures thereof.

In certain embodiments, the at least one solvent comprises a solvent mixture, such as a solvent mixture comprising a glycol ether and an alcohol. In certain embodiments, the solvent mixture may be present in an amount ranging from about 0.1 wt % to about 10 wt %, such as from about 1 wt % to about 4 wt % or about 2 wt % to about 3 wt %, such as about 3 wt %, by weight of the home care composition.

In certain embodiments, the home care composition disclosed herein further comprises at least one emulsifying agent, e.g., a salt, that can optionally aid in emulsifying the components of the home care composition, e.g., a fragrance. The at least one emulsifying agent can be chosen from any emulsifying agent known in the art, including, for example, an alcohol solvent as described above and salts such as sodium chloride, magnesium chloride, calcium chloride, potassium sulfate, lactate salts, and citrate salts, among others.

In certain embodiments, the home care composition disclosed herein further comprises water. Under one embodiment, at least about 80% of the home care composition is comprised of water. Under one embodiment, at least about 85% of the home care composition is comprised of water. Under one embodiment, at least about 86% of the home care composition is comprised of water. Under one embodiment, at least about 87% of the home care composition is comprised of water. Under one embodiment, at least about 88% of the home care composition is comprised of water. Under one embodiment, at least about 89% of the home care composition is comprised of water. Under one embodiment, at least about 90% of the home care composition is comprised of water. Under one embodiment, at least about 91% of the home care composition is comprised of water. Under one embodiment, at least about 92% of the home care composition is comprised of water. Under one embodiment, water is the major component of the home care composition.

In certain embodiments, the home care composition may also be a concentrate, comprising lower amounts of water. In certain embodiments of the home care composition disclosed herein, the customer, or an intermediate party, may dilute a concentrate with water to obtain a suitable solution.

In certain embodiments, the home care composition disclosed herein may be in the form of a liquid spray.

The home care composition disclosed herein may further comprise at least one additional antimicrobial agent in addition to citric acid. In certain embodiments, the at least one additional antimicrobial agent is an antimicrobial quaternary ammonium compound. Illustrative examples of antimicrobial quaternary ammonium compound include benzethonium chloride (BEC), benzalkonium chloride (BKC), polydiallyldimethylammonium chloride (poly-DADMAC), didecyl dimethyl ammonium chloride (DDAC), cetylpyridinium chloride, cetyltrimethylammonium chloride (CTAC), and cetyltrimethylammonium bromide (CTAB). In certain embodiments, the home care composition disclosed herein is free of or substantially free of an antimicrobial agent in addition to citric acid. In certain embodiments, the home care composition disclosed herein is free of or substantially free of any one of or all of BEC, BKC, poly-DADMAC, DDAC, cetylpyridinium chloride, CTAC, and/or CTAB. In certain embodiments, the home care composition disclosed herein is free of or substantially free of DDAC.

In certain embodiments, the home care composition disclosed herein further comprises at least one additional ingredient in addition to citric acid that may act as an antimicrobial boosting agent, e.g., to increase the antimicrobial effectiveness of the citric acid. In certain embodiments, the antimicrobial boosting agent is selected from a chelating agent. In certain embodiments, the antimicrobial boosting agent is selected from ethylhexylglycerin, caprylyl glycol, or a combination thereof. Ethylhexylglycerin is a glyceryl ether having the formula C₁₁H₂₄O₃ that may also be used as a preservative agent. Caprylyl glycol, otherwise known as 1,2-octanediol, has the formula C₈H₁₈O₂ or CH₃ (CH₂)₅CHOHCH₂OH. The at least one additional ingredient, such as at least one of ethylhexylglycerin or caprylyl glycol, may in certain embodiments be added to the home care composition disclosed herein in an amount ranging from about 0.01 wt % to about 5 wt %, such as about 0.01 wt % to about 4 wt %, about 0.01 wt % to about 3 wt %, about 0.01 wt % to about 2 wt %, about 0.01 wt % to about 1 wt %; from about 0.1 wt % to about 4 wt %, about 0.1 wt % to about 3 wt %, about 0.1 wt % to about 2 wt %, about 0.1 wt % to about 1 wt %; from about 0.25 wt % to about 4 wt %, about 0.25 wt % to about 3 wt %, about 0.25 wt % to about 2 wt %, about 0.25 wt % to about 1 wt %, or about 0.25 wt % to about 0.5 wt %, such as about 0.25 wt %, by weight of the home care composition.

In certain embodiments disclosed herein, the home care composition may further comprise at least one chelating agent. In certain embodiments, the at least one chelating agent is selected from ethylenediaminetetraacetic acid (EDTA), tetrasodium N,N-bis(carboxymethyl)-L-glutamate (GLDA), sodium iminodisuccinate (IDSNa), diethylene triamine pentaacetic acid (DTPA), 1-hydroxyethane, 1,1-disphosphoric acid (HEDP), and combinations thereof. In certain embodiments, the at least one chelating agent is present in the home care composition in an amount ranging from about 0.001 wt % to about 1 wt %, such as from about 0.01 wt % to about 0.5 wt %, about 0.1 wt % to about 0.4 wt %, about 0.1 wt % to about 0.3 wt %, about 0.1 wt % to about 0.2 wt %, or about 0.12 wt %, by weight of the composition.

In certain embodiments disclosed herein, the home care composition may further comprise at least one pH modifying agent. The home care composition may have a pH of 6 to 11 or, e.g., from about 6 to about 10, about 6 to about 9, about 6 to about 8, or about 6 to about 7; from about 7 to about 10, about 7 to about 9, or about 7 to about 8; from about 8 to about 10, about 8 to about 9, about 9 to about 11, or any range or subrange thereof. Additionally or alternatively, the home care composition may have a pH of about 7 to 10 or, e.g., about 7.5 to about 10, about 7.5 to about 9.5, about 7.5 to about 8.5, about 7.5 to about 8, or any range or subrange thereof.

The pH modifying agent may be selected from any pH modifier known in the art. Examples of suitable acids for decreasing the pH of the home care composition include, but are not limited to, citric acid, acetic acid, lactic acid, and the like. Examples of suitable bases for increasing the pH of the home care composition include, but are not limited to, sodium hydroxide, potassium hydroxide, caustic soda, amines, ammonia, and the like. In certain embodiments, the pH modifying agent is a base, and the pH of the home care composition ranges from about 7 to 14, such as from about 7.5 to about 9.5, or from about 8.5 to about 9.5.

The amount of the pH modifying agent in the home care composition may be based on the desired pH of the final form of home care composition. For instance, the total amount of the pH modifying agent may range from about 0.05 wt % to about 20 wt %, based on the total weight of the home care composition. In some instances, the total amount of the pH modifying agent is from about 0.05 wt % to about 15 wt %, about 0.1 to about 10 wt %, or about 0.12 wt % to about 6 wt %, including ranges and sub-ranges thereof, based on the total weight of the home care composition. In certain embodiments, the home care composition disclosed herein do not comprise citric acid as a pH modifying agent. In certain embodiments, the home care composition disclosed herein are free of or are substantially free of citric acid as a pH modifying agent. In certain embodiments, the pH modifying agent is a base (e.g., sodium hydroxide or caustic soda), and is added to the home care composition in an amount ranging from about 1 wt % to about 6 wt % in order to adjust the pH of the home care composition to a pH of about 7 to about 14 (e.g., about 7.5 to about 9.5).

The home care compositions may, in some cases, comprise one or more preservatives. The home care composition may be formulated to have preservative(s) in an amount from about 0.1 wt % to about 12 wt %, based on the total weight of the home care composition. For example, the preservative(s) may be present in the home care composition in an amount from about 0.1 wt % to about 12 wt %, about 0.1 wt % to about 10 wt %, about 0.1 wt % to about 8 wt %, about 0.1 wt % to about 6 wt %, about 0.1 wt % to about 4 wt %, about 0.1 wt % to about 3 wt %, about 0.1 wt % to about 2 wt %, about 0.1 wt % to about 1 wt %; from about 1 wt % to about 12 wt %, about 1 wt % to about 10 wt %, about 1 wt % to about 8 wt %, about 1 wt % to about 6 wt %, about 1 wt % to about 4 wt %, about 1 wt % to about 3 wt %; from about 2 wt % to about 12 wt %, about 2 wt % to about 10 wt %, about 2 wt % to about 8 wt %, about 2 wt % to about 6 wt %, about 2 wt % to about 4 wt %, about 2 wt % to about 3 wt %; from about 3 wt % to about 12 wt %, about 3 wt % to about 10 wt %, about 3 wt % to about 8 wt %, about 3 wt % to about 6 wt %, about 3 wt % to about 4 wt %; from about 5 wt % to about 12 wt %, about 5 wt % to about 10 wt %, about 5 wt % to about 8 wt %, or any range or subrange thereof, based on the total weight of the home care composition.

The one or more preservatives may include at least one of lactic acid, benzalkonium chloride, sodium benzoate, potassium sorbate, hydroxyacetophenone, ethylhexylglycerin, or a combination of thereof. Additional examples of preservatives that may be incorporated in the preservative system include, but are not limited to, 4-hydroxy benzoic acid, benzoic acid, sorbic acid, dehydroacetic acid, triclosan, benzyl alcohol, chlorophenesin, salicylic acid, hydroxy acetophenone, caprylhydroxamic acid, phenethyl alcohol, p-anisic acid, glyceryl caprylate, levulinic acid, sodium levulinate, propanediol, hexanediol, pentylene glycol, capryloyl glycine, methylpropanediol, phenylpropanol, sodium anisate, or a combination of two or more thereof.

The preservative system may, in some cases, include or exclude one or more of the following preservatives: chlorhexidine, chlorhexidine digluconate, chlorhexidine dihydrochloride, chlorhexidine diacetate, chlorhexidine gluconate, chlorhexidine hydrochloride, chlorhexidine phosphanilate, chlorphensin, benzoic acid or a salt or ester thereof (e.g., sodium benzoate), propionic acid or a salt thereof, salicylic acid or a salt thereof, sorbic acid or a salt thereof (e.g. potassium sorbate), formaldehyde, paraformaldehyde, zinc pyrithione, inorganic sulphites, hydrogen sulphites, chlorobutanol, 4-hydroxybenzoic acid or a salt or ester thereof (e.g. methylparaben, ethylparaben, propylparaben), dehydroacetic acid and/or a salt thereof (e.g. sodium dehydroacetate), formic acid or a salt thereof, dibromohexamidine isethionate; thimerosal, phenylmecuric salts, undecylenic acid or a salt thereof, hexetidine, bronopol, 5-bromo-5-nitro-1,3-dioxane, dichlorobenzyl alcohol, benzyl alcohol, triclocarban, chlororesol, triclosan, chloroxylenol, imidazolidinyl urea, polyaminopropyl biguanide, phenoxyethanol, methenamine, quaternium-15, climbazole, DMDM hydantoin, 1-hydroxy-4-methyl-6-(2,4,4-trimethylenepentyl)-2 pyridon, piroctone olamine, bromochlorophene, 0-cymen-5-ol, methylchloroisothiazolinone, methylisothiazololinone, mixtures of methylchloroisothiazolinone and methylisothiazololinone, chlorophene, chloroacetamide, phenoxyisoproponol, alkyl (C₁₂-C₂₂) trimethyl ammonium bromide, alkyl (C₁₂-C₂₂) trimethyl ammonium chloride, dimethyl oxazolidine, diazolidinyl urea, hexamidine, hexamidine diisethionate, hexamidine diparaben, hexamidine paraben, glutaral, 7-ethylbicyclooxazolidine, sodium hydroxymethylaminoacetate, silver chloride, benzethonium chloride, benzalkonium chloride, benzalkonium bromide, benzalkonium saccharinate, benzylhemiformal, iodopropynyl butylcarbamate, silver citrate, or a combination of two or more thereof.

The home care composition may include one or more fragrances. The amount of fragrances present in the home care composition may be from about 0.01 wt % to about 4 wt %, about 0.01 wt % to about 3 wt %, about 0.01 wt % to about 2 wt %, about 0.01 wt % to about 1 wt %, about 0.01 wt % to about 0.5 wt %, about 0.01 wt % to about 0.3 wt %; about 0.1 wt % to about 5 wt %, about 0.1 wt % to about 4 wt %, about 0.1 wt % to about 3 wt %, about 0.1 wt % to about 2 wt %, about 0.1 wt % to about 1 wt %, about 0.1 wt % to about 0.5 wt %, about 0.1 wt % to about 0.3 wt %; about 0.3 wt % to about 5 wt %, about 0.3 wt % to about 4 wt %, about 0.3 wt % to about 3 wt %, about 0.3 wt % to about 2 wt %, about 0.3 wt % to about 1 wt %; about 0.5 wt % to about 5 wt %, about 0.5 wt % to about 4 wt %, about 0.5 wt % to about 3 wt %, about 0.5 wt % to about 2 wt %, about 0.5 wt % to about 1 wt %; about 1 wt % to about 5 wt %, about 1 wt % to about 4 wt %, about 1 wt % to about 3 wt %, about 1 wt % to about 2 wt %; about 2 wt % to about 5 wt %, about 2 wt % to about 4 wt %, about 2 wt % to about 3 wt %; about 3 wt % to about 5 wt %, about 3 wt % to about 4 wt %, including any range or subrange therebetween, based on the total weight of the home care composition.

Non-limiting examples of fragrances and perfumes include odor compounds selected from: 7-acetyl-1,2,3,4,5,6,7,8-octahydro-1,1,6,7-tetramethylnaphthalene, α-ionone, β-ionone, γ-ionone α-isomethylionone, methylcedrylone, methyl dihydrojasmonate, methyl 1,6,10-trimethyl-2,5,9-cyclododecatrien-1-yl ketone, 7-acetyl-1,1,3,4,4,6-hexamethyltetralin, 4-acetyl-6-tert-butyl-1,1-dimethylindane, hydroxyphenylbutanone, benzophenone, methyl β-naphthyl ketone, 6-acetyl-1,1,2,3,3,5-hexamethylindane, 5-acetyl-3-isopropyl-1,1,2,6-tetramethylindane, 1-dodecanal, 4-(4-hydroxy-4-methylpentyl)-3-cyclohexene-1-carboxaldehyde, 7-hydroxy-3,7-dimethyloctanal, 10-undecen-1-al, isohexenylcyclohexylcarboxaldehyde, formyltricyclodecane, condensation products of hydroxycitronellal and methyl anthranilate, condensation products of hydroxycitronellal and indole, condensation products of phenylacetaldehyde and indole, 2-methyl-3-(para-tert-butylphenyl) propionaldehyde, ethylvanillin, heliotropin, hexylcinnamaldehyde, amylcinnamaldehyde, 2-methyl-2-(isopropylphenyl) propionaldehyde, coumarin, γ-decalactone, cyclopentadecanolide, 16-hydroxy-9-hexadecenoic acid lactone, 1,3,4,6,7,8-hexahydro-4,6,6,7,8,8-hexamethylcyclopenta-γ-2-benzopyran, β-naphthol methyl ambroxane, dodecahydro-3a,6,6,9a-tetramethylnaphtho[2,1b]furan, cedrol, 5-(2,2,3-trimethylcyclopent-3-enyl)-3-methylpentan-2-ol, 2-ethyl-4-(2,2,3-trimethyl-3-cyclopenten-1-yl)-2-buten-1-ol, caryophyllene alcohol, tricyclodecenyl propionate, tricyclodecenyl acetate, benzyl salicylate, cedryl acetate, and tert-butylcyclohexyl acetate.

Other fragrances may include odor compounds selected from essential oils, resinoids and resins from a large number of sources, such as, for example, Peru balsam, olibanum resinoid, styrax, labdanum resin, nutmeg, cassia oil, benzoin resin, coriander, and lavandin.

Further examples of fragrances include odor compounds selected from phenylethyl alcohol, terpineol, linalool, linalyl acetate, geraniol, nerol, 2-(1,1-dimethylethyl)cyclo-hexanol acetate, benzyl acetate, and eugenol. The fragrances or perfumes can be used as single substances or in a mixture with one another.

The home care compositions disclosed herein may further comprise one or more colorants. The colorants may be a pigment, a dye, or mixtures thereof. Non-limiting examples of pigments include titanium dioxide, zinc oxide, kaolin, mica etc. Non-limiting examples of dyes include food dyes suitable for food, drug and cosmetic applications, and mixtures thereof. Some color agents (colorants) are known as FD&C dyes. The colorants may be present in an amount ranging from about 0.0001 wt % to about 0.4 wt %, including all percentages and subranges therebetween, based on the total weight of the home care composition. In some embodiments, the colorants may be present in an amount ranging from about 0.001 wt % to about 4 wt %, such as 0.005 wt % to about 0.01 wt %, or from about 0.007 wt % to about 0.01 wt %, including all percentages and subranges therebetween, based on the total weight of the home care composition.

In addition to the aforementioned components, the home care composition disclosed herein may further comprises additional ingredients as recognized in the art. By way of non-limiting example, additional ingredients may include stabilizers, diluents, antioxidants, and the like.

In certain embodiments, the home care composition may be a disinfecting (e.g., antimicrobial) home care composition. In certain embodiments, the disinfecting home care composition has antibacterial properties, such as an ability to kill or reduce a population of bacteria, e.g., Gram-negative bacteria and/or Gram-positive bacteria. In certain embodiments, the disinfecting home care composition disclosed herein provides at least a 1-log reduction in the bacterial population samples, such as at least a 2-log reduction, at least a 3-log reduction, at least a 4-log reduction, at least a 5-log reduction, or at least a 6-log reduction in the bacterial population. In certain embodiments, the disinfecting home care compositions disclosed herein have a micro robustness index of at least about 0.85, such as at least about 0.90, at least about 0.95, 1.0, at least about 1.1, at least about 1.2, at least about 1.3, or at least about 1.4.

In certain embodiments disclosed herein, the home care composition has antimicrobial activity, including, for example, at least one of antibacterial activity and/or antifungal activity (e.g., anti-mold and/or anti-yeast). In certain embodiments, the antibacterial activity is a Gram-negative antibacterial activity, and in certain embodiment, the antibacterial activity is a Gram-positive antibacterial activity. In certain embodiments, the antibacterial activity is both Gram-negative and Gram-positive.

Antimicrobial activity can be measured by any means known in the art, including, for example, by performing micro robustness testing and/or short interval kill testing on a composition. As used herein, micro robustness testing refers to a screening process for assessing the micro robustness of a composition, such as a home care composition as disclosed herein. The micro robustness is a quantitative measure of a composition's ability to withstand microbial insult, and encompasses the rate of kill of a bacterial inoculum as well as a total kill level. The quantitative measure may be expressed as the Area Under the Curve (AUC). To calculate a micro robustness index, compositions are challenged by inoculation with a specific microorganism or a pool of microorganisms. At selected time intervals (e.g., 0, 2, 4, 6, 24, 48, 72, and/or 96 hours), the challenged composition is sampled. Dilutions and platings are performed to recover the surviving microorganisms, and the log difference in the bacterial counts (CFU/g) between the composition and an inoculum control is calculated over time to determine the AUC. In certain embodiments disclosed herein, the home care composition has a micro robustness index of at least about 0.85, such as at least about 0.90, at least about 0.95, 1.0, at least about 1.1, at least about 1.2, at least about 1.3, or at least about 1.4.

An alternative or additional means of assessing antimicrobial activity is a short interval kill time (SIKT) test. A SIKT test may be used to determine in vitro short-term antimicrobial activity of compositions in a solution. The SIKT test assesses the reduction of a microbial population of a test microorganism or pool of microorganisms after exposure to a test composition. In certain embodiments, the composition may be mixed with a bacterial inoculum for a selected time interval, after which the test composition is neutralized, and the surviving bacteria measured. The bacterial reduction in the test composition may be calculated as compared to a control/placebo composition, water, or a time-zero control. In certain embodiments disclosed herein, the home care composition provides at least a 1-log reduction in the bacterial population samples, such as at least a 2-log reduction, at least a 3-log reduction, at least a 4-log reduction, at least a 5-log reduction, or at least a 6-log reduction in the bacterial population.

Exemplary Gram-negative bacteria include Acinetobacter baumannii, Acinetobacter haemolyticus, Actinobacillus actinomycetemcomitans, Aeromonas hydrophila, Bacteroides fragilis, Bacteroides theataioatamicron, Bacteroides distasonis, Bacteroides ovatus, Bacteroides vulgatus, Bartonella Quintana, Bordetella pertussis, Brucella melitensis, Burkholderia cepacia, Burkholderia pseudomallei, Burkholderia mallei, Fusobacterium, Prevotella corporis, Prevotella intermedia, Prevotella endodontalis, Porphyromonas asaccharolytica, Campylobacter jejuni, Campylobacter fetus, Campylobacter coli, Chlamydia pneumoniae, Chlamydia trachomatis, Citrobacter freundii, Citrobacter koseri, Coxiella burnetii, Edwarsiella tarda, Eikenella corrodens, Enterobacter cloacae, Enterobacter aerogenes, Enterobacter agglomerans, Escherichia coli, Francisella tularensis, Haemophilus influenzae, Haemophilus ducreyi, Helicobacter pylori, Kingella kingae, Klebsiella pneumoniae, Klebsiella oxytoca, Klebsiella rhinoscleromatis, Klebsiella ozaenae, Legionella penumophila, Moraxella catarrhalis, Morganella morganii, Neisseria gonorrhoeae, Neisseria meningitidis, Pseudomonas aeruginosa, Pasteurella multocida, Plesiomonas shigelloides, Proteus mirabilis, Proteus vulgaris, Proteus penneri, Proteus myxofaciens, Providencia stuartii, Providencia rettgeri, Providencia alcalifaciens, Pseudomonas fluorescens, Salmonella typhi, Salmonella typhimurium, Salmonella paratyphi, Serratia marcescens, Shigella flexneri, Shigella boydii, Shigella sonnei, Shigella dysenteriae, Stenotrophomonas maltophilia, Streptobacillus moniliformis, Vibrio cholerae, Vibrio parahaemolyticus, Vibrio vulnificus, Vibrio alginolyticus, Yersinia enterocolitica, Yersinia pestis, Yersinia pseudotuberculosis, Chlamydia pneumoniae, Chlamydia trachomatis, Ricketsia prowazekii, Coxiella burnetii, Ehrlichia chafeensis and/or Bartonella hensenae. In certain embodiments, the home care compositions disclosed herein kill Gram-negative bacteria including at least one of E. coli and P. aeruginosa.

Exemplary Gram-positive bacteria include Staphylococcus aureus, Listeria monocytogenes, Staphylococcus epidermidis, Staphylococcus saprophyticus, Staphylococcus simulans, Staphylococcus intermedius, Staphylococcus sciuri, Staphylococcus hyicus, Streptococcus suis, Streptococcus pyogenes, Streptococcus agalactiae, Streptococcus dysgalactiae, Streptococcus pneumoniae, Streptococcus anginosis, Streptococcus mitis, Streptococcus sanguinis, Streptococcus bovis, Streptococcus salivarius, Streptococcus mutans, Enterococcus faecalis, Enterococcus hirae, and Enterococcus faecium. In certain embodiments, the home care compositions disclosed herein kill Gram-positive bacteria including at least one of S. aureus and E. hirai.

Further disclosed herein are methods of cleaning a substrate using the home care composition, such as a disinfecting home care composition, disclosed herein. In certain embodiments, the method comprises the step of applying the home care composition to a substrate; and optionally wiping the composition across the substrate. The application step may be performed in any manner that will deliver a sufficient amount of the home care composition to the substrate. Examples of such application step include spraying a portion of the surface with the home care composition from a spray bottle, spraying a portion of the surface with the home care composition from an aerosol can, pouring onto a portion of the surface the home care composition from a bottle, and like. Under one embodiment, the application step delivers the home care composition to a portion of the substrate which the user desires to clean. Under one embodiment, the application step delivers the home care composition to all of the substrate which is desired to be cleaned.

The optional wiping step may be performed to provide a coating of the home care composition to the entire substrate which the user desires to clean. Further, the wiping step is performed to remove the home care composition, along with any dirt or debris carried away by the home care composition. The wiping step may be performed by any suitable tool. Examples of tools used to wipe the home care composition include a rag, cloth towel, paper towel, micro fiber cloth, newspaper, paper, squeegee, sponge, brush, hand, and like.

### EXAMPLES

### Example 1

Six example home care compositions (Compositions 1-6) were prepared according to aspects of the disclosure, as provided in Table 1 below. Two reference control compositions (Compositions A and B) were also prepared and are provided in Table 2, neither of which contained citric acid. Composition A did not contain any additional antimicrobial agents, while Composition B contained the antimicrobial compound DDAC and a stabilizer.

As shown in Table 1, parameters were varied to include different concentrations of citric acid, pH, and the presence of additional ingredients, including ethylhexylglycerin (EHG) and caprylyl glycol (CG), which were selected as potential antibacterial boosters. CG corresponds to a medium chain terminal diol, and is expected to have broad antimicrobial activity, including against yeast and mold. EHG may enhance antibacterial properties of other molecules, e.g., chelating agents. Because of the hydrophilic-lipophilic balance of EHG, it is expected to reduce the surface tension of the membrane, thereby improving the contact of any antimicrobial molecules. See, e.g., Varvaresou, A. et al., Self-preserving Cosmetics, Intl J Cosmetic Sci 2009, 31(3):163-175.

TABLE 1
Test Compositions 1-6

| | | | | | Comp. 5 | Comp. 6 |
|---|---|---|---|---|---|---|
| | Comp. 1 | Comp. 2 | Comp. 3 | Comp. 4 | CA 5% + | CA 5% + |
| | CA 1% | CA 1% | CA 5% | CA 5% | EHG | CG |
| Ingredient | pH~8.5* | pH~9.5* | pH~8.5* | pH~9.5* | pH~8.5* | pH~8.5* |
| Demineralized water | QS 100 | QS 100 | QS 100 | QS 100 | QS 100 | QS 100 |
| Surfactant | 5.00 | 5.00 | 5.00 | 5.00 | 5.00 | 5.00 |
| Anti-oxidizing agent | 0.015 | 0.015 | 0.015 | 0.015 | 0.015 | 0.015 |
| Chelant | 0.12 | 0.12 | 0.12 | 0.12 | 0.12 | 0.12 |
| Solvents | 2.00 | 2.00 | 2.00 | 2.00 | 2.00 | 2.00 |
| Fragrance/colorants | 0.33 | 0.33 | 0.33 | 0.33 | 0.33 | 0.33 |
| Citric acid anhydrous | 1.00 | 1.00 | 5.00 | 5.00 | 5.00 | 5.00 |
| Ethylhexylglycerin | — | — | — | — | 0.25 | — |
| Caprylyl glycol | — | — | — | — | — | 0.25 |

*It is noted that a pH adjusting agent was added to adjust the composition to the desired pH. Grams were added into the sample until the corresponding pH was reached.

TABLE 2
Comparative Compositions A and B

| | Comp. A | Comp. B |
|---|---|---|
| Ingredient | pH ~8.5 | pH ~9.3 |
| Demineralized water | QS 100 | QS 100 |
| Surfactant | 5.00 | 5.00 |
| Anti-oxidizing agent | 0.015 | 0.015 |
| Chelant | 0.12 | 0.12 |
| Solvents | 2.00 | 2.00 |
| Fragrance/colorants | 0.33 | 0.33 |
| Di-n-decylmethylammonium | — | 1.63 |
| chloride 40 | | |
| Formula Stabilizer | — | 0.4 |

### Example 2

The compositions described above in Example 1 were tested to assess their stability under various conditions (54° C., room temperature, and 5-8° C.) over a two-week time period. The pH was measured initially and then again every week, and any changes in appearance were also recorded. The compositions were further assessed using micro-robustness testing, and samples that met the required specifications were then evaluated via Short Interval Kill Tests (SIKTs).

Micro robustness testing: The micro robustness of all samples was evaluated to determine which samples met a micro robustness index (MRI) of at least 0.85, against a pool of both Gram positive and Gram negative bacteria species. Table 3 below shows the micro robustness testing results for eight compositions prepared. As shown, Composition A, which contained no antimicrobial ingredients, did not obtain an MRI of 0.85, though it did obtain an MRI of 0.65, showing that the ingredients can contribute to its preservation and might eventually contribute to SIKT activity. Composition B, containing the antimicrobial DDAC, has an MRI of 1.84. Both the compositions (Compositions #1 and #2) containing 1% citric acid failed to meet the MRI specifications, and no significant difference could be observed between the two compositions at a pH of 8.5 and 9.5. Notably, Compositions #1 and #2 delivered a lower MRI than the Composition A, containing no antimicrobial ingredients at all. Each composition containing 5% citric acid achieved an MRI greater than 0.85. As with Compositions #1 and #2, the MRI results of Compositions #3-6 did not vary significantly at different pHs of 8.5 and 9.5. The addition of EHG or CG could not be differentiated in the test results. Without wishing to be bound by theory, it is possible that this lack of differentiation may be due to the detection limits of the methods, as well as the contribution of other ingredients, including the concentration of citric acid.

TABLE 3
Micro Robustness Testing Results

| Composition | MRI |
|---|---|
| Comparative Comp. A | 0.64 |
| Comparative Comp. B | 1.84 |
| #1 | 0.37 |
| #2 | 0.36 |
| #3 | 1.46 |
| #4 | 1.44 |
| #5 | 1.39 |
| #6 | 1.48 |

Short Interval Kill Tests (SIKTs): SIKTs were performed on both of the comparative Compositions A and B and on the four compositions (Compositions #3-6) that passed the micro robustness testing with an MRI of at least 0.85. The results are shown below in Table 4.

TABLE 4
SIKT Results

| | Log reduction | | | |
|---|---|---|---|---|
| Composition | E. coli | S. aureus | P. aeruginosa | E. hirai |
| Comparative Comp. A | 1.2 | 1.4 | 2.4 | 5 |
| Comparative Comp. B | 6 | 6.1 | 6.1 | 6 |
| #3 | 6 | 4 | 6.1 | 6 |
| #4 | 6 | 4.3 | 6.1 | 6 |
| #5 | 6 | 4.5 | 6.1 | 6 |
| #6 | 6 | 4.5 | 6.1 | 6 |

As shown, four microorganisms were evaluated, including both Gram negative (E. coli and P. aeruginosa) and Gram positive (S. aureus and E. hirai) bacteria. Comparative Composition A showed some log reduction, especially against E. hirai. Comparative Composition B containing DDAC resulted in log reductions of at least 6 for each organism. Likewise, Compositions #3-6 showed antibacterial activity when tested in neat conditions. In all cases, log reductions of at least 6 were obtained against E. coli, P. aeruginosa, and E. hirae, and a log reduction of at least 4 was obtained against S. aureus. Having a pH of 9.5 slightly increased the log reductions. Maintaining the pH at 8.5 and incorporating EHG or CG also slightly increased the performance.

Based on these results, the use of 5% citric acid is shown both to aid in preserving the composition against bacterial contamination and also to have antibacterial properties when incorporated into a cleaning spray composition.

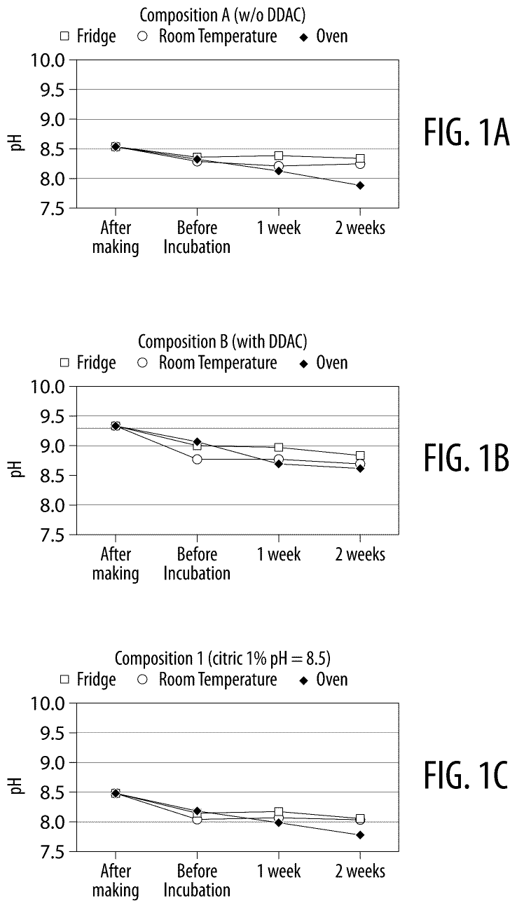

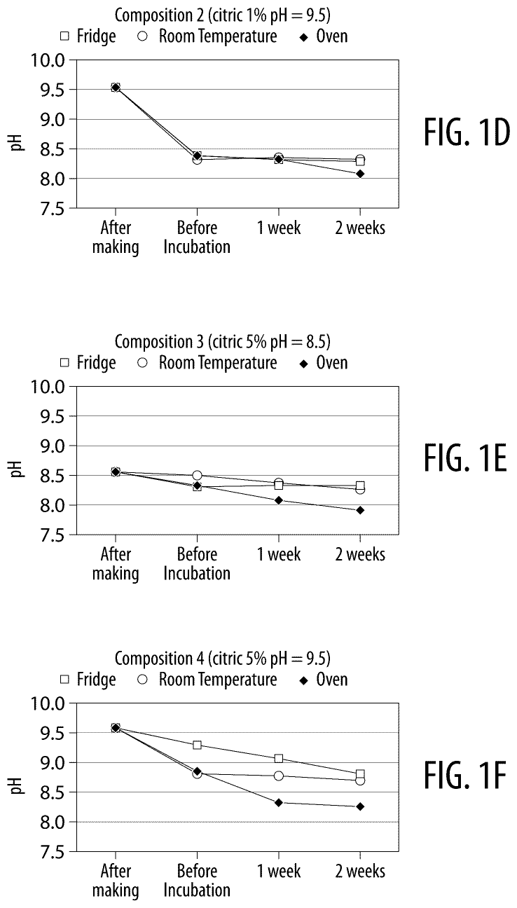

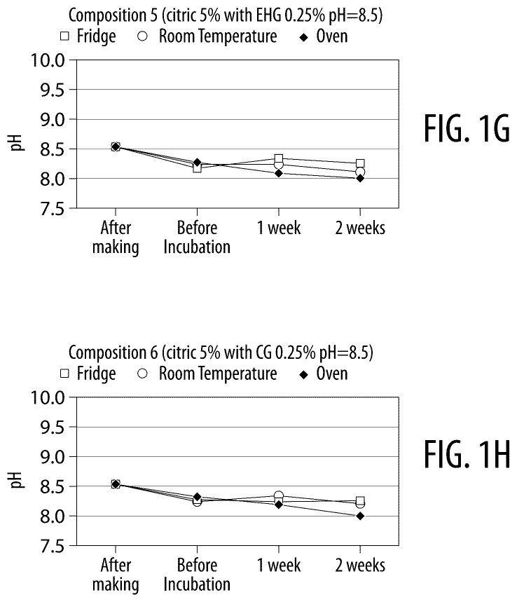

Stability Testing: As discussed above, the pH and visual appearance of the compositions were tracked immediately after making and after a two-week period to observe any changes. FIG. 1A-1H shows the pH of each composition over time. As shown, samples having an original pH of 9.5 (Compositions #2 and #4, shown in FIG. 1D and FIG. 1F, respectively) showed the largest pH changes over time, especially when incubated at a temperature of 54° C. For all samples, the pH variation was highest in the first two days (before incubation), followed by an almost constant rate in the following days. Without wishing to be bound by theory, it is noted that, based on the room temperature pH profiles and the fact the micro robustness tests were conducted approximately one week after manufacture, it is possible that the tested pH was lower than the stated 8.5 to 9.5, e.g., such as lower by about 0.5 to about 1.0 pH point in some instances.

The appearance of the compositions was also monitored over two weeks. The Compositions A and B showed no difference over any of the temperature conditions, maintaining their characteristic color with no turbidity. Compositions #1 and #2 (1% citric acid) also showed no visible appearance changes. Compositions #3 and #4 (5% citric acid) showed no immediate changes (i.e., no turbidity) after making. Samples kept at 5-8° C. showed no changes over time, although samples at room temperature showed a slight color change and samples at 54° C. showed a degree of phase separation. Room temperature samples were further evaluated after a few weeks, and similar phase separation was observed. Compositions #5 and #6 (EHG and CG, respectively) showed an immediate change in turbidity after making. Composition #5 (EHG) showed a slight decrease in color at all conditions but no phase separation. Composition #6 (CG) showed phase separation at all conditions.

### Example 3

Additional compositions were prepared with two different concentrations of citric acid (2.5% and 4%) and two pHs (7.5 and 8.5). The compositions are shown below in Table 5.

TABLE 5
Additional Test Compositions

| | Comp. 7 | Comp. 8 | Comp. 9 | Comp. 10 |
|---|---|---|---|---|
| | CA 2.5% | CA 2.5% | CA 4% | CA 4% |
| Ingredient | pH ~7.5* | pH ~8.5* | pH ~7.5* | pH ~8.5* |
| Demineralized water | QS 100 | QS 100 | QS 100 | QS 100 |
| Surfactant | 5.00 | 5.00 | 5.00 | 5.00 |
| Antioxidizing agent | 0.015 | 0.015 | 0.015 | 0.015 |
| Chelant | 0.12 | 0.12 | 0.12 | 0.12 |
| Solvents | 2.00 | 2.00 | 2.00 | 2.00 |
| Fragrance/colorants | 0.33 | 0.33 | 0.33 | 0.33 |
| Citric acid anhydrous | 2.50 | 2.50 | 4.00 | 4.00 |
| Ethylhexylglycerin | — | — | — | — |
| Caprylyl glycol | — | — | — | — |

*It is noted that the pH adjusting agent was added to adjust the composition to the desired pH. Grams were added into the sample until the corresponding pH was reached.

As in Example 1, to adjust the pH, a pH adjusting agent was added to the formulations. The appearance and pH of the samples was monitored for a two week period at three different temperature conditions: (1) refrigeration (5-8° C.), room temperature, and oven (49° C.).

Micro Robustness and Short Interval Kill Tests (SIKTs): Micro Robustness tests were performed on the compositions following the same procedure disclosed above in Example 2. Samples that met the threshold micro robustness were then evaluated via SIKTs (5 minute neat test time against ATCC 8739 E. coli, ATCC 6538 S. aureus, ATCC 15442 P. aeruginosa, and ATCC 10541 E. hirae). Neat tests were conducted directly using the sample, i.e., facing the sample against the bacteria). The reaction was then stopped at the time of interest, and dilutions were made, i.e., recovery of any surviving microorganisms. Afterwards, log reductions were then calculated.

The micro robustness of all samples was evaluated to determine which samples met a micro robustness index (MRI) of at least 0.85. Table 6 shows the MRT results obtained for the different samples. As shown, the reference Compositions A and B behaved as expected. Composition A, containing no antimicrobial ingredients, did not reach an MRI of 0.85, although it did obtain an index of 0.56, showing as in previous results that the ingredients can contribute to its preservation. Composition B, containing DDAC, surpassed the known specifications for MRT with a 1.8 MRI, just as observed in previous experiments.

TABLE 6
MRI and SIKT log reductions

| | | | Comp. 7 | Comp. 8 | Comp. 9 | Comp. 10 |
|---|---|---|---|---|---|---|
| | Comp. A | Comp. B | CA 2.5% | CA 2.5% | CA 4% | CA 4% |
| | pH~8.5 | pH~9.3 | pH~7.5 | pH~8.5 | pH~7.5 | pH~8.5 |
| MRI | 0.56 | 1.8 | 0.62 | 0.7 | 0.71 | 1.09 |

SIKT log reduction:

| | | | | | | |
|---|---|---|---|---|---|---|
| E. coli | 1.5 | 6 | — | 5 | — | 6 |
| S. aureus | 2 | 6.1 | — | 2.2 | — | 2.6 |
| P. aeruginosa | 4 | 6.1 | — | 6.1 | — | 6.1 |
| E. hirae | 4.8 | 6 | — | 4.8 | — | 6 |

Compositions 7 and 8, having a citric acid concentration of 2.5%, did not meet the threshold MRI of 0.85, with each demonstrating MRIs of 0.62 and 0.7, respectively. These results were, however, higher than previous citric acid samples at 1% concentration (having MRIs of 0.37 and 0.36). Nonetheless, a slight increase in the MRI was observed in Composition 8 (pH of about 8.5) when compared to Composition 7 (pH of about 7.5).

Compositions 9 and 10, each having a citric acid concentration of 4%, delivered MRIs of 0.71 and 1.09, respectively. Composition 9 showed how the difference in pH may affect robustness, as it had 1.5% more citric acid than Composition 8, but nonetheless achieved similar results.

Considering the MRT results, Compositions 8 and 10 were selected for further SIKTs. The results are shown in Table 6 above. As shown, four different microorganisms were explored, including both Gram-positive and Gram-negative bacteria. Composition A (without any antibacterial ingredients) again delivered some log reductions, confirming that the formula has some degree of antibacterial properties itself. In previous experimentation, E. hirae achieved 5 log reductions, which comports with the results obtained herein. Composition A was also shown to have 4 log reductions against P. aeruginosa, while in previous experimentations, only 2.4 log reductions was achieved. Composition B comprising DDAC delivered similar results as in previous testing, demonstrating the known antibacterial properties of DDAC.

Composition 8, although demonstrating an MRI of 0.7, showed over 4 log reductions for E. coli, P. aeruginosa, and E. hirae. Composition 8 showed 2.6 log reductions against S. Aureus. Thus, Composition 8 still delivered good antibacterial activity at a 2.5% citric acid concentration.

Overall, the results confirm that S. aureus remains a challenging bacteria. This is in agreement with previous experiments and what has been reported in the literature. While not wishing to be bound by theory, it is hypothesized that the difference between Gram-negative and Gram-positive bacterial cell walls, with an apparent lack of a lipopolysaccharide layer in the latter, might contribute to the differences observed. (Burel 2021).

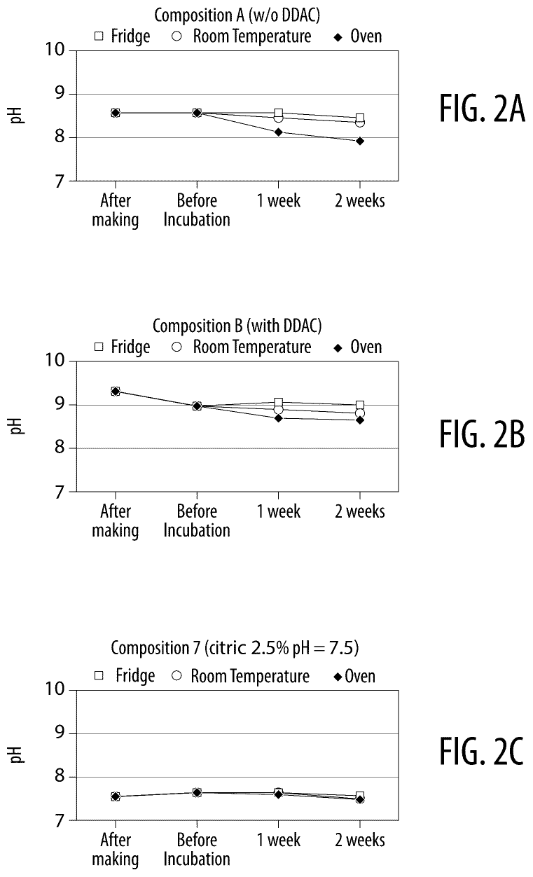

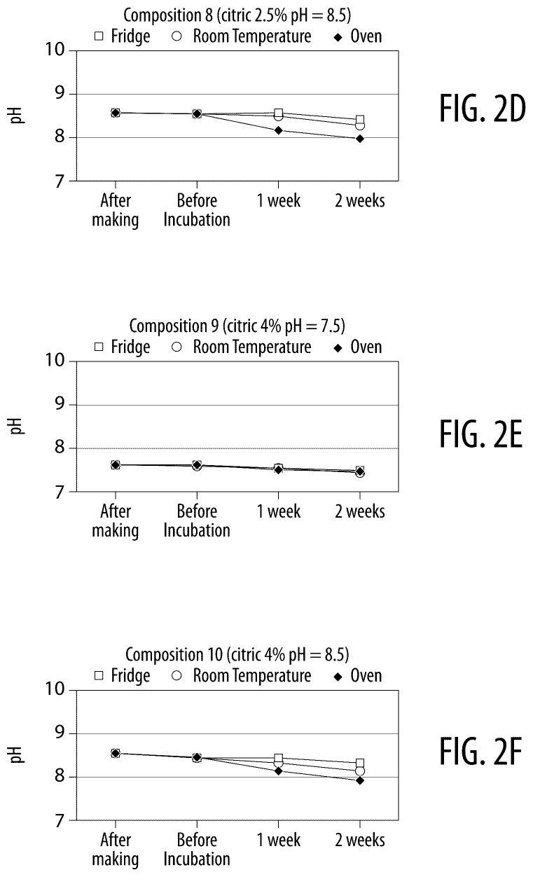

Stability results: As discussed above, the pH and appearance were tracked immediately after the compositions were prepared and after two weeks at either 5-8° C., room temperature, or 49° C. FIGS. 2A-2F show the pH changes over time for Composition A (FIG. 2A), Composition B (FIG. 2B), Composition 7 (FIG. 2C), Composition 8 (FIG. 2D), Composition 9 (FIG. 2E), and Composition 10 (FIG. 2F).

As shown, for the refrigerated samples (5-8° C.) and those at room temperature, all of the compositions showed very stable pH behavior over 2 weeks. At oven conditions (49° C.), some compositions showed slight pH changes over time. Both Compositions A and B showed about 0.65 difference in pH over time. Compositions 7 and 9 (pH 7.5) showed basically no changes at oven conditions, and Compositions 8 and 10 (pH 8.5) showed slight changes of about 0.6 difference in pH after 2 weeks.

With respect to appearance, all samples has their characteristic color with no turbidity after making. Both Compositions A and B maintained this color appearance after two weeks at all three temperature conditions employed. Compositions 7 and 8 likewise maintained their color appearance in the refrigerator and at room temperature during the two week period. At oven conditions (49° C.), a layer could be observed at the top. After two weeks, the layer turned slightly darker. Compositions 9 and 10 had a similar behavior as Compositions 7 and 8. No impact was observed in the samples incubated in the refrigerator or at room temperature, and at oven conditions, a layer was observed at the top, which got darker over time. Based on these observations, it appears that the incorporation of citric acid at 2.5%-4% may present changes in appearance when the formulation is kept at higher temperatures.

The present disclosure has been described with reference to exemplary implementations. Although a limited number of implementations have been shown and described, it will be appreciated by those skilled in the art that changes may be made in these implementations without departing from the principles and spirit of the preceding detailed description. It is intended that the present disclosure be construed as including all such modifications and alterations insofar as they come within the scope of the appended claims or the equivalents thereof.

What is claimed is:

1. A home care composition comprising:
citric acid in an amount greater than about 1 wt %, based on the total weight of the home care composition;
at least one surfactant; and
at least one solvent;
wherein the home care composition has a pH ranging from about 7 to about 14.

2. The home care composition according to claim 1, wherein the citric acid is present in an amount of greater than about 1 wt % to about 5 wt %, based on the total weight of the home care composition.

3. The home care composition according to claim 1, wherein the home care composition has a pH ranging from about 7 to about 10.

4. The home care composition according to claim 1, wherein the at least one surfactant is an amphoteric surfactant.

5. The home care composition according to claim 4, wherein the amphoteric surfactant is lauryl dimethyl amine oxide.

6. The home care composition according to claim 1, the at least one surfactant is present in the home care composition in an amount ranging from about 1 wt % to about 20 wt %, based on the total weight of the home care composition.

7. The home care composition according to claim 1, further comprising at least one fragrance present in an amount ranging from about 0.01 wt % to about 4 wt %, based on the total weight of the home care composition.

8. The home care composition according to claim 1, wherein the at least one solvent is selected from a glycol ether and an alcohol.

9. The home care composition according to claim 8, wherein the at least one solvent comprises propylene glycol N-butyl ether and ethyl alcohol.

10. The home care composition according to claim 1, further comprising at least one antimicrobial boosting agent.

11. The home care composition according to claim 10, wherein the at least one antimicrobial boosting agent is selected from ethylhexylglycerin and caprylyl glycol.

12. The home care composition according to claim 1, further comprising a base as a pH modifying agent.

13. The home care composition according to claim 12, wherein the base is sodium hydroxide.

14. The home care composition according to claim 1, wherein the home care composition has a micro robustness index of at least about 0.85.

15. The home care composition according to claim 1, wherein the home care composition provides at least a 2-log reduction in a bacterial population.

16. The home care composition according to claim 15, wherein the bacterial population comprises at least one bacteria selected from Gram-negative bacteria.

17. The home care composition according to claim 15, wherein the bacterial population comprises at least one bacteria selected from Gram-positive bacteria.

18. A method of disinfecting a surface by killing at least one bacteria, the method comprising applying the home care composition according to claim 1.

19. The method according to claim 18, wherein the home care composition is applied as a liquid spray.

20. The method according to claim 18, wherein the method provides at least a 2-log reduction in a bacterial population on the surface.
